(19) United States
(12) Patent Application Publication
(10) Pub. No.: US 2007/0234846 A1
(43) Pub. Date: Oct. 11, 2007

(54) Variable geared bicycle pedal

(76) Inventor: David Sun, Arcadia, CA (US)

Correspondence Address: LAW OFFICES OF CLEMENT CHENG, 17220 NEWHOPE STREET #127, FOUNTAIN VALLEY, CA, 92708, US

(21) Appl. No.: 11/376,257

(22) Filed: Mar. 15, 2006

(51) Int. Cl. G05G 1/14

(52) U.S. Cl. 74/594.3

(57) ABSTRACT

A pedal propulsion mechanism has a first crank arm mechanically connecting to a first gear set and a drive wheel. A second crank arm mechanically connects to a second gear set and the drive wheel. On a first crank arm power stroke the first crank arm drives the drive wheel and first gear set driving a second gear set driving the second crank arm. The first and second gear set have a gear ratio so that on a first crank arm power stroke the first crank arm drives the drive wheel and also drives the first gear set that drives a second gear set that drives the second crank arm at a rotational speed different than that of the first crank arm.

### BACKGROUND OF THE INVENTION

A. Field of the Invention

The present invention relates to a pedal propulsion mechanism. More particularly, the present invention relates to a pedal drive gear mechanism which provides two independent cranks having simultaneous front positions with no interval between alternating upper dead points for high speed pedaling as well as reduced exertion to propel a vehicle including bicycle.

B. Description of the Prior Art

Pedal drivetrains of various kinds are used in most bicycles to transmit pedal pushes into rotations of crankset, which fit into the bottom bracket of the bicycle. Attached to the crank is the chain ring that drives the chain, which in turn rotates the rear wheel via rear sprockets. Between the chain and rear wheel may be interspersed various gearing systems, which vary by the number of rear wheel revolutions produced by each turn of the pedals.

Technology has been developed along the bicycle history to efficiently use a limited amount of power of cyclists' legs by providing means of variable gear ratio to maintain an optimum pedaling speed while covering varied terrain. The base idea of a bicycle crank is that a crank turn is completed by two consecutive 180° rotations about an axle by alternating legs of a cyclist pedaling on opposite ends of an elongated crank.

During its constant-speed 360° drive cycle two upper dead points are given to the legs consecutively because two legs must be at 180° apart from each other. No suggestions have been made to date in rotational pedal driving to completely eliminate the dead point interval so that two legs are always in driving ranges in front of the crank axle.

Offering various degrees of efficiency or speed improvement various prior arts are found including U.S. Pat. Nos. 5,899,477 and 6,840,136. Although one prior art mechanism is deemed to be more efficient or faster than others, comparison of the suggestions concludes that the difference is small.

Alternative drivetrains are also known such as two separate crank bars linearly reciprocating under the cyclist's depressions that are changed into rotational power through another transmission device connected to the rear wheel. Such mechanisms have shown transmission efficiency below an accepted standard, which typically ranges between 82% and 92% depending on the gear ratio selected. Track racing bikes have achieved transmission efficiencies over 99% meaning nearly all the energy put in at the pedals reaches the wheel.

An object of the present invention is to provide a simple gear drive mechanism to automatically position the non-driving side of crank at the top dead point without a delay. Another object of the present invention is to provide a drive mechanism with novel characteristic of pedaling readily replaceable of existing drives of human powered vehicles that for people needing greater crank customization.

### SUMMARY OF THE INVENTION

The present invention provides a rotational pedaling with variable speed revolution of alternating pedals allowing a user to shorten the time to reach each the subsequent upper dead point through an automatic pedal positioning without adverse affect against cadences, which is the speed at which a cyclist comfortably revolves the crank in balance through such a low pedal exertion to compensate the accelerated pedal positioning.

A pedal propulsion mechanism has a first crank arm mechanically connecting-to a first gear set and a drive wheel. A second crank arm mechanically connects to a second gear set and the drive wheel. On a first crank arm power stroke the first crank arm drives the drive wheel and first gear set driving a second gear set driving the second crank arm. The first and second gear set have a gear ratio so that on a first crank arm power stroke the first crank arm drives the drive wheel and also drives the first gear set that drives a second gear set that drives the second crank arm at a rotational speed different than that of the first crank arm.

Thus, the present invention can eliminate the interval dead point so that one of two legs is always in the power stroke driving range in front of the crank axle. The gear ratios can be changed and varied from the preferred embodiment of a 90° driving, also called peddling or power stroke and a 270° recovery stroke. The pedal gearing can be modified in a number of ways. For example, the pedaling can be reversed so that a user pedals in reverse.

A pedal propulsion mechanism according to an embodiment of the present invention has a right pedal rotationally connected to a right side crank section. A left pedal is rotationally connected to a left side crank section.

In the best mode, when the right pedal is at its upper dead point, 45° upward from the ground where it is ready to be depressed by an operator or cyclist, the left pedal is at its lower dead point, which is 90° downward from the upper dead point. The two pedals and their cranks will generally assume one of the two positions in front of their common axis of rotation except brief automatic whirls of alternate pedal/crank assemblies over 270° covering the distance from the bottom dead point to the subsequent upper dead point.

In one example, while the right crank makes a 90° power drive that is directly transmitted to a sprocket and assumes the rotational position switched between the left crank, part of the right crank drive branches to the left crank that is geared to power a 270° turn and will end up in the upper dead point switched between the right crank. Therefore, the recovery crank can always take power from the power crank allowing faster travel of the recovery crank.

The power drive of the alternate left crank can be immediately followed the automatic positioning of the right crank with the assistance of the left crank and so on. On the pedal propulsion mechanism, the operator will get through four consecutive upper dead points in one cycle of the drive wheel, chain wheel or sprocket operation with no lost time and wasted energy otherwise required to bring the non-drive side of the conventional crank back to position.

Embodiments of the invention will now be described by way of example with reference to the accompanying drawings.

### BRIEF DESCRIPTION OF THE DRAWINGS

FIG. 1 is an exploded perspective view of a double-front pedal propulsion mechanism according to a first embodiment of the present invention.

FIG. 2 is a cross sectional view of the pedal mechanism of FIG. 1 in operation.

FIG. 3 is a table to show the relative rotational positions of the pedal mechanism components of FIG. 2 wherein 90° is the angular distance of power drive of a part and 270° is the angular movement of a part in speed multiplying unique to the present for providing no-interval dead points.

FIG. 4 shows the rotational positions of both legs on the pedal wherein the right pedal drive through 90° effects the left pedal rotation of 270° or triple fast movement toward its upper front dead point as well as a quarter turn of the sprocket.

FIG. 5 is a partially exploded perspective view of a double-front pedal propulsion mechanism according to a second embodiment of the present invention.

FIG. 6 is an exploded perspective view of FIG. 5 showing the detailed gear meshes in operation.

FIG. 7 is a cross sectional view of the pedal mechanism of FIG. 6.

FIG. 8 is a table to show the relative rotational positions of the pedal mechanism components of FIG. 7.

FIG. 9 is a cross sectional view of a pedal mechanism according to a third embodiment of the present invention.

FIG. 10 is a table to show the relative rotational positions of the pedal mechanism components of FIG. 9.

The figures show three embodiments in succession. Similar reference numbers denote corresponding features throughout the attached drawings.

### DETAILED DESCRIPTION OF THE PREFERRED EMBODIMENT

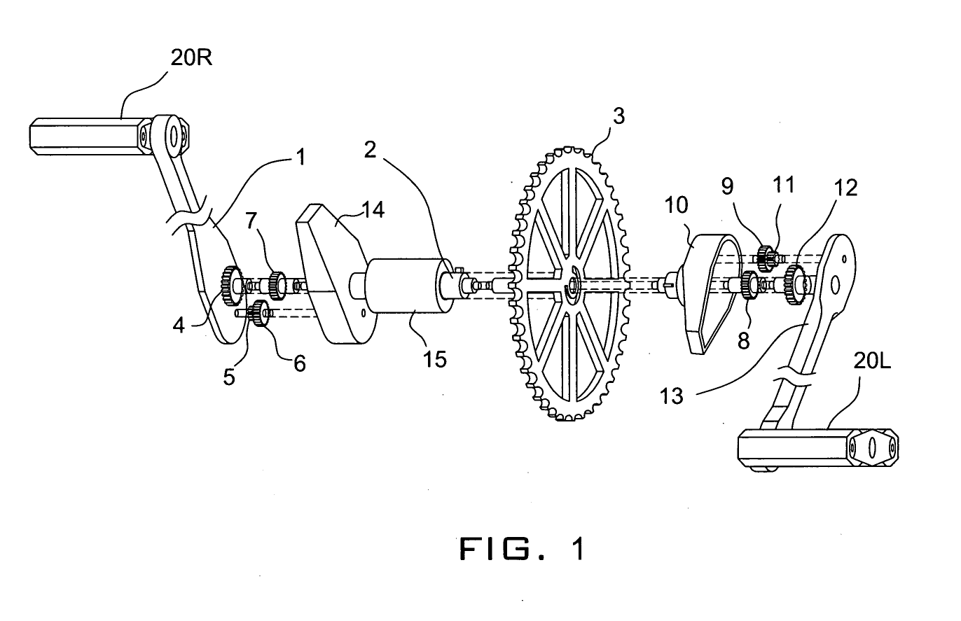

As seen in FIG. 1, a pedal propulsion mechanism according to the first embodiment of the present invention is shown where a right pedal 20R is rotationally connected to a right side crank section 1. Here, we can call the right crank the first crank. A first crank arm is mechanically connected to a first gear set and a drive wheel. A left pedal 20L is rotationally connected to a left side crank section 13. The left pedal is connected to the second crank arm mechanically connecting to a second gear set and the drive wheel. The pedal is mounted in swivel connection with the pedal crank arm. The right pedal 20R connects in swivel connection to the right pedal crank arm 1. The left pedal 20L connects in swivel connection to the right pedal crank arm 13.

The right pedal 20R is shown at its upper dead point, 45° upward from the ground where it is ready to be depressed by an operator or cyclist whereas the left pedal 20L is at its lower dead point, which is 90° downward from the upper dead point. The upward most point is the dead point. FIG. 1 shows and exploded view where after assembly the bicycle would be traveling toward the viewer. The right crank is powering the bicycle mechanism in a power or drive stroke. The left crank used in a recovery stroke.

The two pedals 20R and 20L and their cranks 1 and 10 will generally assume one of the two positions in front of their common axis of rotation except brief automatic whirls of alternate pedal/crank assemblies over 270° covering the distance from the bottom dead point to the subsequent upper dead point.

In the illustrated example, while the right crank 1 makes a 90° power drive that is directly transmitted to a sprocket 3 and assumes the rotational position switched between the left crank 10, part of the right crank 1 drive branches to the left crank 10 that is geared to make a 270° whirl and will end up in the upper dead point switched between the right crank 1.

Next comes the power drive of the alternate left crank 10 accompanied by the automatic positioning of the right crank 1 with the assistance of the left crank 10 and so on. In the best mode, the illustrated pedal propulsion mechanism the operator will experience four consecutive upper dead points per cycle of the sprocket operation with no lost time and wasted energy otherwise required to bring the non-drive side of the conventional crank back to position.

A first crank arm power stroke has the first crank arm driving the drive wheel and also driving the first gear set that drives a second gear set that drives the second crank arm. The second crank arm power stroke has the second crank arm drives the drive wheel and also drives the second gear set that drives a first gear set that drives the first crank arm.

From the crank section 1 a clutch section 2 extends to engage a sprocket 3 that meshes with a chain (not shown), which will rotate the rear wheel via rear sprockets in case of a bicycle drivetrain. Encased between crank sections 1 and 2 are three gears meshed together to provide a unique crank positioning according to the present invention. The left pedal 20L is connected to the crank section 10 that has a similar gear set as the one in crank section 1 but is terminated at a shorter shank of a clutch 13. The clutch may be formed as a protrusion on the crank arm that engages with a semi circular slot of the sprocket 3. The sprocket is also called the drive wheel or chain wheel. The clutch is formed to push the sprocket forward in the direction of promoting bicycle travel. FIG. 1 shows the crank arm 1 connected to a gear 4 that is connected to other gears 5, 6, 7, 8, 9, 11, 12 either by the direct rigid connection or by meshed connection. A left gear housing 10 or a right gear housing 14 can be incorporated as part of the gear assembly. Alternatively, the housing can be incorporated into the structural portion of the right crank arm 1, or the left crank arm 13 so that the gears are housed within the crank arm.

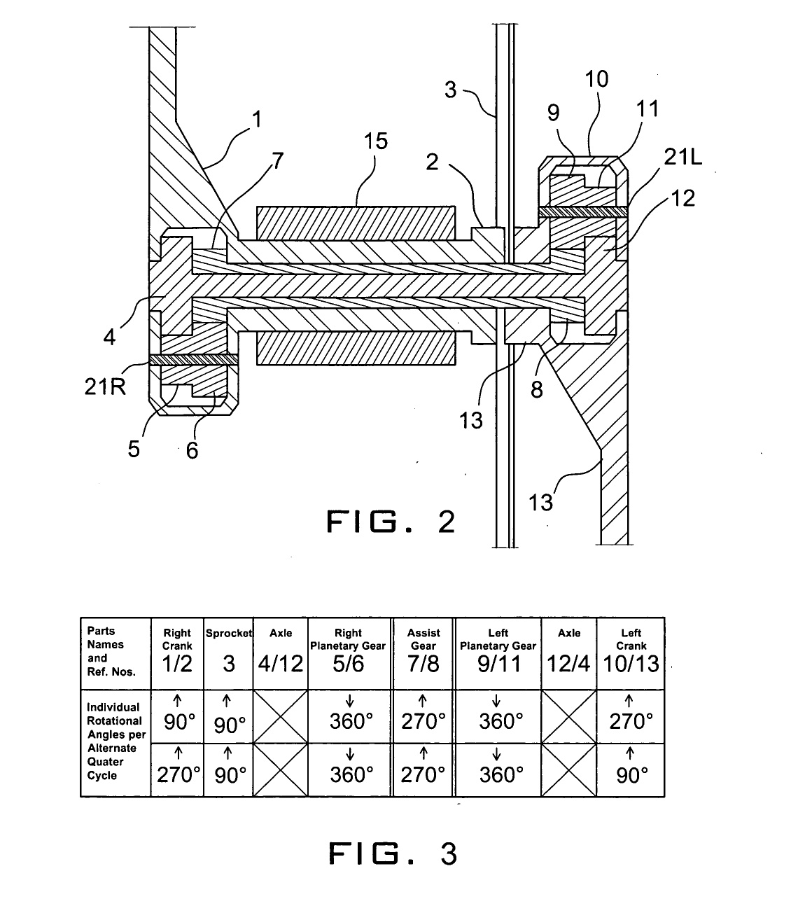

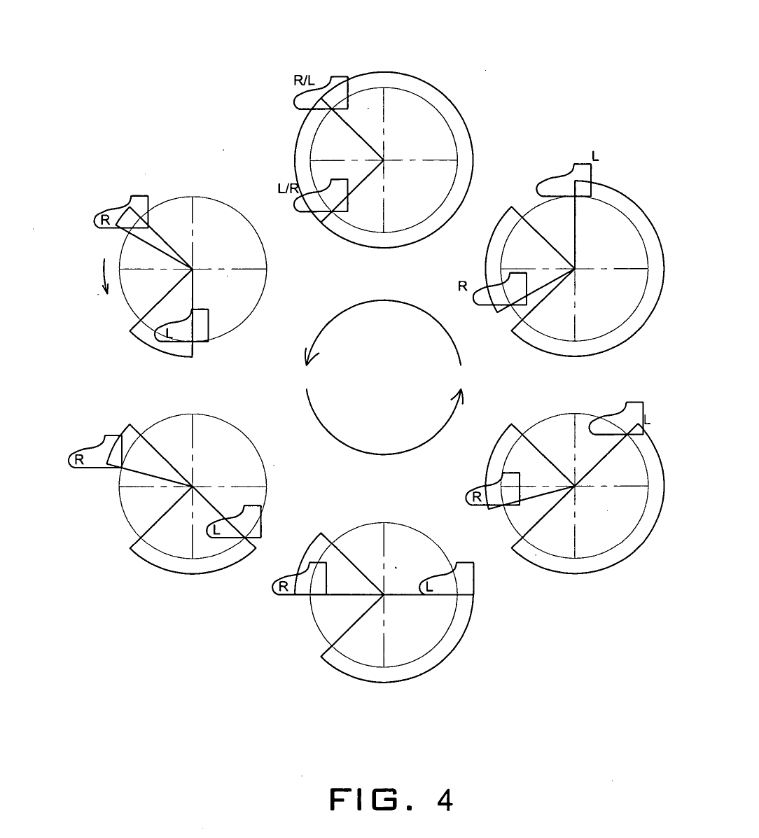

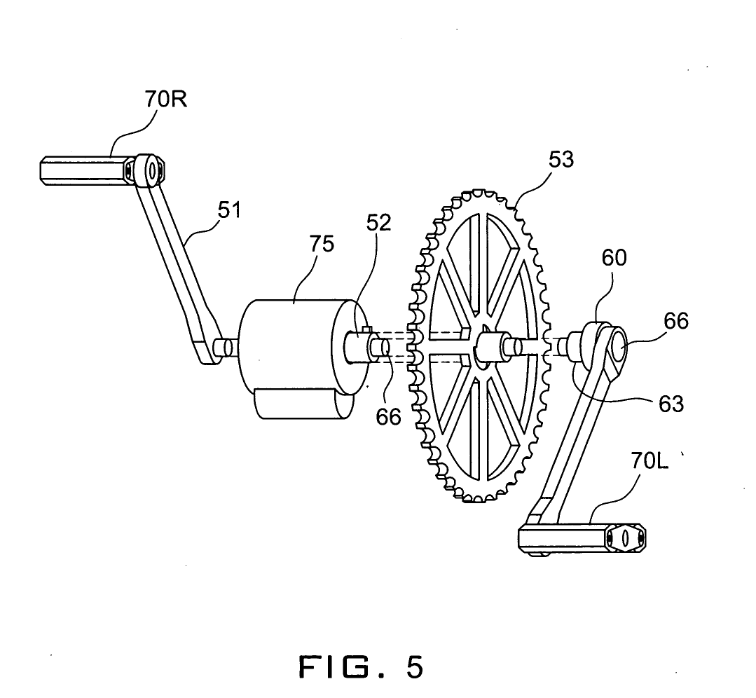

Referring to the illustration of the inventive propulsion mechanism in cross section in FIG. 2 and the individual rotational angles of the respective components listed in the table of FIG. 3, the operation of the present invention will now be more detailed. The larger gear 12 has an engaging surface of only a quarter and the smaller gear 8 has an engaging surface of only three-quarters. The larger gear 4 has an engaging surface of one-quarter and the smaller gear 7 has an engaging surface of three-quarters. The engaging surfaces and non-engaging surfaces operate to vary or otherwise modulate gear ratio to provide a variable speed pedaling. The stepped or modal gear set configuration is preferred over a continuously variable gear set. As presented herein, the double step provides a pair of speeds, fast and slow. By this disclosure, addition of additional steps would not be difficult for a person of ordinary skill in the art. The planetary embodiment is the best mode for normal bicycle usage.

This is a simpler version of the gear transmission provided by the present invention. The mechanism generally comprises the right crank 1 having a long hollow axle ending with a clutch 2 connected to the sprocket 3 and a single rotor with a smaller gear 5 and a bigger gear 6 rotationally installed inside thereof. The mechanism at its other end similarly comprises the left crank 10 having its own single rotor with a smaller gear 11 and a bigger gear 9, which have the same dimensions as the opposite gears 5 and 6 of the right crank 1. Here, the operation is the same. The first crank powers the first gear set that powers the second gear set that powers the second crank. The term “gear set” can refer to a single gear or multiple gears. It is obvious to replace a single gear with multiple gears. Also, it is obvious to add additional gears. For example, in FIG. 2 gear 11 and gear 9 are each rotationally connected to each other so that they rotate together. The additional gear can be added on the opposite side of the gear 11 and gear 9 allowing a double planetary configuration. The double planetary configuration allows smaller gears set. In certain configurations the miniaturization decreases total weight.

Though the cranks 1 and 10 are shown facing the opposite directions from each other, they are adapted to face the same direction normally in the common front active range in an alternating rotational manner. Two such cranks 1 and 10 are connected by coaxial rotor shafts in a symmetrical configuration. The inner of the coaxial rotor is stationary as the cranks 1 and 10 rotate about it and has opposite ends bored in the respective cranks 1 and 10 and an end gear 4 meshed with the smaller gear 5 at the right side and an opposite end gear 12 meshed with the smaller gear 11 at the left side rotationally connecting the two small gears 5 and 11. The outer portion of the coaxial rotor has at its opposite ends gears 7 and 8 adapted to rotationally connect the bigger gears 6 and 9 of the cranks 1 and 10 to each other.

The gear ratio between the end gears 4/12 and the smaller gears 5/11 is such that the smaller gear 5 or 11 displacement thru 90° about the inner rotor axis during the 90° of power dive of its crank 1 or 10 effects a complete revolution of 360° of the smaller gear 5 or 11 about its own axis due to the engagement with the stationary end gear 4 or 12.

At the same time, one of the bigger gears 6 and 9 make the same integral revolution of 360°, which is relayed to the other of the bigger gears 6 and 9 through the end gears 7 and 8 of the outer coaxial rotor. The end gears 7 and 8 rotate together 270° by the 360° rotation of the bigger gear 6 or 9.

Therefore, when the operator pushes the crank 1 at the upper point downward 90°, The right crank rotates 90° and the chain wheel three travels 90°. The right planetary gear rotates 360° and the assistance or transmission gear 7 and gear 8 turns 270°. In turn, the left crank 13 rotates 270°. After the last crank rotates 270°, the left crank engages chain wheel 3.

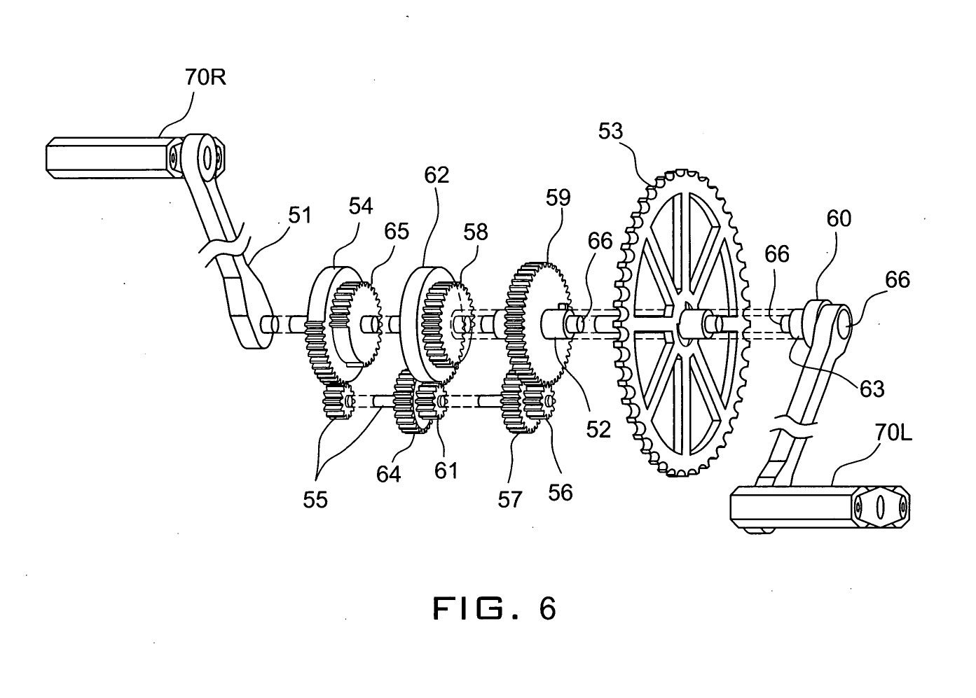

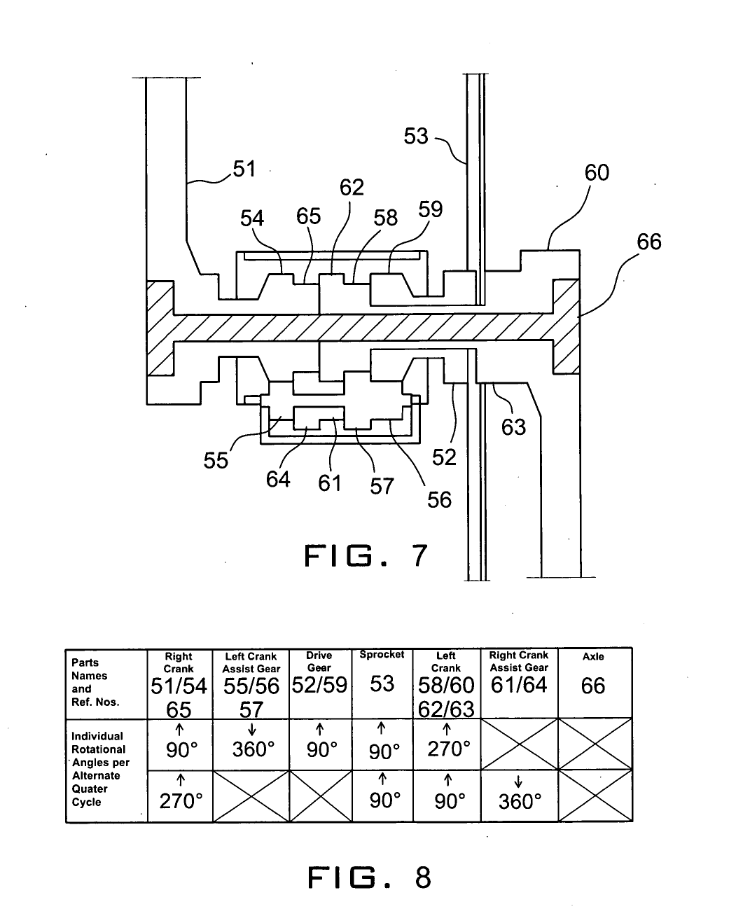

Referring now to the illustration of the second embodiment of the inventive propulsion mechanism in FIGS. 6 and 7 and the individual rotational angles of the respective components listed in the table of FIG. 8, the operation of the present invention will be more detailed.

Generally speaking first, a right pedal 70R/crank 51 assembly has its own group of gears including an integral rotor having a bigger gear 54 and a smaller gear 65 while a left pedal 70L/crank 60 assembly has its own integral rotor having a bigger gear 62 and a smaller gear 58. The rotors at the two sides are supported coaxially on a center axle 66 facing each other and connected indirectly through connecting gears, which are adapted to provide a cross mesh between the opposing rotor gears so that the connecting gears transmit the right crank 51 drive to a sprocket 53 and a position-assisting power to the left crank 60 and transmit the left crank 60 position-assisting power to the right crank 51 alternately.

Gear 55 meshes with gear 54 that has mesh connection only on a quarter of the total gear surface. The quarter represents the quarter turn of power stroke. Gear 64 is meshed to gear 65. Gear 65 has 270° of active surface representing 270° of recovery stroke. Gear 62 is analogous to gear 54 and both have only a mesh connection on a quarter of their surface. In this way, gear 54 and 65 alternate the rear ratio between the planetary axis and the main axis. The planetary axis holds gears 55, 64, 61, 57, and 56. The main axis holds the remainder of the rotational elements.

FIG. 7 shows a cross section view of the second embodiment with a table FIG. 8 that shows rotational operation.

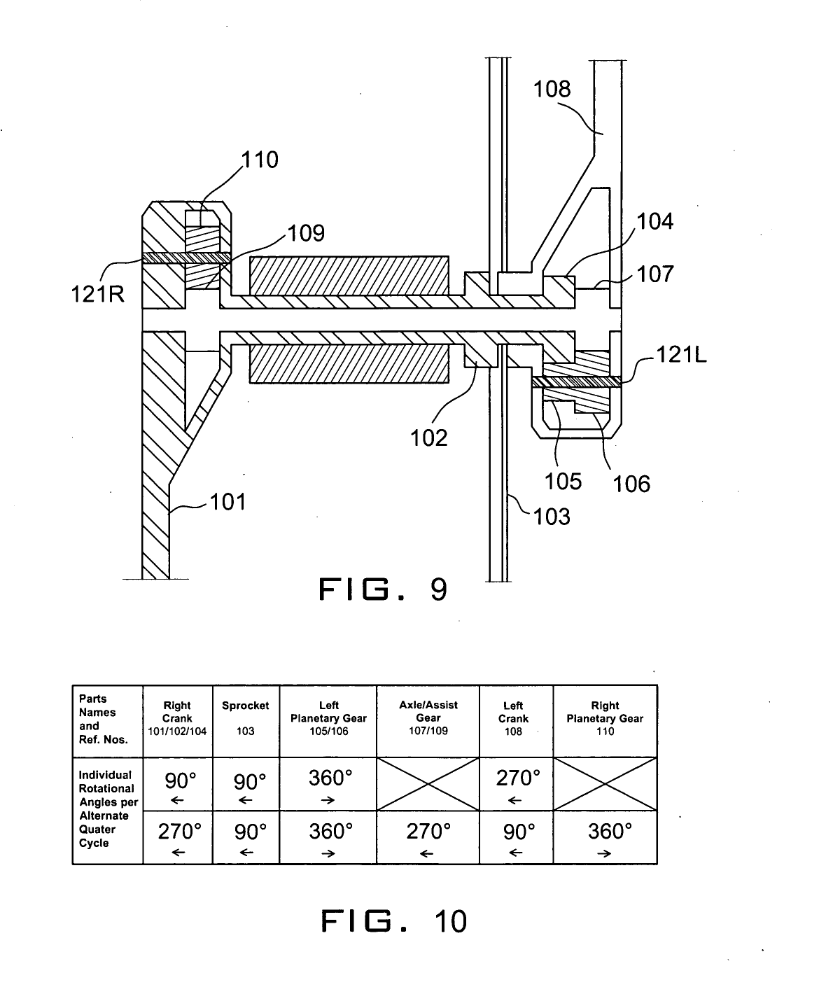

FIG. 9 is a diagram of a simplified configuration having the same parts, but making simplifications. FIG. 9 should be understood from the perspective of the above specification. FIG. 9 is the third embodiment. The right planetary crank axle 121 R connects with planetary gear 110 that meshes with gear 109. Gear 109 can be integrally formed with gear 107. The left planetary crank axle 121 L connects with planetary gear 105 and gear 106. The output is the same as the second embodiment. As can be seen here, one of the gear sets is simplified by removing a planetary gear.

As seen in FIG. 10, the chart shows the right crank 101 moving 90 degrees rotating the sprocket 103 by 90 degrees which moves the left planetary gear 105, 106 by 360 degrees. The axle assistance gear 107, 109 does not rotate because it is threaded the same as the second embodiment that has only partial threading. The axle assistance gear thus does not move. The left crank then moves 270 degrees. After the right pedal power cycle is over, the threading of the gears makes the left crank engage into power cycle position and operate moving 90 degrees that rotates all planetary gears 360 degrees which rotates of the sprocket 90 degrees, which rotates the right crank by 270 degrees.

The second embodiment is a preferred configuration when considering implementation on larger vehicles. The third embodiment is a preferred configuration when considering implementation on lighter vehicles.

As an additional feature, the gear 4 and gear 12 can be made so that is the axle can slide in either direction of its axis so that a user may lock the pin into a fixed connection so that as the gears become locked and not movable relative to each other. A variety of mechanical methods can create the blocking feature. This blocking feature should be activated when the pedals and cranks are at 180° from each other as in an ordinary bicycle configuration. It is also possible to configure the blocking pin so that the shaft blocks the gears immovably when the pedals and cranks are more or less than 180° from each other, however this is not preferred because of cadence and rider balance issues. The blocking feature can be implemented by an external clip or pin that is inserted through the mechanism to bind the gearing.

Therefore, while the presently preferred form of the super fast double-front pedal propulsion has been shown and described, and several modifications thereof discussed, persons skilled in this art will readily appreciate that various additional changes and modifications may be made without departing from the spirit of the invention, as defined and differentiated by the following claims.

1. A pedal propulsion mechanism comprising:
a first crank arm mechanically connecting to a first gear set and a drive wheel;
a second crank arm mechanically connecting to a second gear set and the drive wheel, wherein on a first crank arm power stroke the first crank arm drives the drive wheel and also drives the first gear set that drives a second gear set that drives the second crank arm;
wherein on a second crank arm power stroke the second crank arm drives the drive wheel and also drives the second gear set that drives a first gear set that drives the first crank arm; and
a pedal driving the first crank arm and second crank arm wherein the pedal revolves around in a circular motion.

2. The pedal propulsion mechanism of claim 1, wherein the first gear set and the second gear set mechanically engage with an outer coaxial shaft rotating about an inner coaxial shaft, wherein said outer coaxial shaft and inner coaxial shaft form a coaxial shaft linkage transmitting rotational energy between the pedals.

3. The pedal propulsion mechanism of claim 1, wherein the first gear set and second gear set have a gear ratio so that on a first crank arm power stroke the first crank arm drives the drive wheel and also drives the first gear set that drives a second gear set that drives the second crank arm at a rotational speed greater than that of the first crank arm; wherein on a second crank arm power stroke the second crank arm drives the drive wheel and also drives the second gear set that drives a first gear set that drives the first crank arm at a rotational speed greater than that of the second crank arm.

4. The pedal propulsion mechanism of claim 3, wherein the first gear set and the second gear set mechanically engage with an outer coaxial shaft rotating about an inner coaxial shaft, wherein said outer coaxial shaft and inner coaxial shaft form a coaxial shaft linkage transmitting rotational energy between the pedals, wherein the first crank arm power stroke is 90° and wherein the first crank arm has a first crank arm recovery stroke which is 270°, wherein the second crank arm power stroke is 90° and wherein the second crank arm has a second crank arm recovery stroke which is 270°.

5. The pedal propulsion mechanism of claim 1, wherein the first gear set and the second gear set are both mounted on the crank arms, wherein the first gear set and the second gear set have a planetary gearing configuration of at least one planetary gear.

6. The pedal propulsion mechanism of claim 5, wherein the first gear set and the second gear set mechanically engage with an outer coaxial shaft rotating about an inner coaxial shaft, wherein said outer coaxial shaft and inner coaxial shaft form a coaxial shaft linkage transmitting rotational energy between the pedals.

7. A pedal propulsion mechanism comprising:
a first crank arm mechanically connecting to a first gear set and a drive wheel;
a second crank arm mechanically connecting to a second gear set and the drive wheel, wherein on a first crank arm power stroke the first crank arm drives the drive wheel and also drives the first gear set that drives a second gear set that drives the second crank arm;
wherein on a second crank arm power stroke the second crank arm drives the drive wheel and also drives the second gear set that drives a first gear set that drives the first crank arm;
wherein the first gear set and second gear set have a gear ratio so that on a first crank arm power stroke the first crank arm drives the drive wheel and also drives the first gear set that drives a second gear set that drives the second crank arm at a rotational speed greater than that of the first crank arm, wherein during the first crank arm power stroke the second crank arm temporarily disengages from the drive wheel; and
wherein on a second crank arm power stroke the second crank arm drives the drive wheel and also drives the second gear set that drives a first gear set that drives the first crank arm at a rotational speed greater than that of the second crank arm, wherein during the second crank arm power stroke the first crank arm temporarily disengages from the drive wheel; and
a pedal driving the first crank arm and second crank arm wherein the pedal revolves around in a circular motion.

8. The pedal propulsion mechanism of claim 7, wherein the first gear set and the second gear set mechanically engage with an outer coaxial shaft rotating about an inner coaxial shaft, wherein said outer coaxial shaft and inner coaxial shaft form a coaxial shaft linkage transmitting rotational energy between the pedals.

9. The pedal propulsion mechanism of claim 7, wherein the first gear set and second gear set have a gear ratio so that on a first crank arm power stroke the first crank arm drives the drive wheel and also drives the first gear set that drives a second gear set that drives the second crank arm at a rotational speed greater than that of the first crank arm; wherein on a second crank arm power stroke the second crank arm drives the drive wheel and also drives the second gear set that drives a first gear set that drives the first crank arm at a rotational speed greater than that of the second crank arm.

10. The pedal propulsion mechanism of claim 9, wherein the first gear set and the second gear set mechanically engage with an outer coaxial shaft rotating about an inner coaxial shaft, wherein said outer coaxial shaft and inner coaxial shaft form a coaxial shaft linkage transmitting rotational energy between the pedals, wherein the first crank arm power stroke is 90° and wherein the first crank arm has a first crank arm recovery stroke which is 270°, wherein the second crank arm power stroke is 90° and wherein the second crank arm has a second crank arm recovery stroke which is 270°.

11. The pedal propulsion mechanism of claim 7, wherein the first gear set and the second gear set are both mounted on the crank arms, wherein the first gear set and the second gear set have a planetary gearing configuration of at least one planetary gear.

12. The pedal propulsion mechanism of claim 11, wherein the first gear set and the second gear set mechanically engage with an outer coaxial shaft rotating about an inner coaxial shaft, wherein said outer coaxial shaft and inner coaxial shaft form a coaxial shaft linkage transmitting rotational energy between the pedals.

13. A pedal propulsion mechanism comprising:
a first crank arm mechanically connecting to a first gear set and a drive wheel;
a second crank arm mechanically connecting to a second gear set and the drive wheel, wherein on a first crank arm power stroke the first crank arm drives the drive wheel and also drives the first gear set that drives a second gear set that drives the second crank arm;
wherein on a second crank arm power stroke the second crank arm drives the drive wheel and also drives the second gear set that drives a first gear set that drives the first crank arm;
wherein the first gear set and second gear set have a gear ratio so that on a first crank arm power stroke the first crank arm drives the drive wheel and also drives the first gear set that drives a second gear set that drives the second crank arm at a rotational speed different than that of the first crank arm; and
wherein on a second crank arm power stroke the second crank arm drives the drive wheel and also drives the second gear set that drives a first gear set that drives the first crank arm at a rotational speed different than that of the second crank arm whereby the angle between the first crank arm and second crank arm vary; and
a pedal driving the first crank arm and second crank arm wherein the pedal revolves around in a circular motion.

14. The pedal propulsion mechanism of claim 13, wherein during the second crank arm power stroke the first crank arm temporarily disengages from the drive wheel; wherein during the first crank arm power stroke the second crank arm temporarily disengages from the drive wheel.

15. The pedal propulsion mechanism of claim 13, wherein the first gear set and the second gear set mechanically engage with an outer coaxial shaft rotating about an inner coaxial shaft, wherein said outer coaxial shaft and inner coaxial shaft form a coaxial shaft linkage transmitting rotational energy between the pedals.

16. The pedal propulsion mechanism of claim 15, wherein during the second crank arm power stroke the first crank arm temporarily disengages from the drive wheel; wherein during the first crank arm power stroke the second crank arm temporarily disengages from the drive wheel, wherein the first crank arm power stroke is 90° and wherein the first crank arm has a first crank arm recovery stroke which is 270°, wherein the second crank arm power stroke is 90° and wherein the second crank arm has a second crank arm recovery stroke which is 270°.

17. The pedal propulsion mechanism of claim 13, wherein the first gear set and the second gear set are both mounted on the crank arms, wherein the first gear set and the second gear set have a planetary gearing configuration of at least one planetary gear.

18. The pedal propulsion mechanism of claim 17, wherein during the second crank arm power stroke the first crank arm temporarily disengages from the drive wheel; wherein during the first crank arm power stroke the second crank arm temporarily disengages from the drive wheel, wherein the first crank arm power stroke is 90° and wherein the first crank arm has a first crank arm recovery stroke which is 270°, wherein the second crank arm power stroke is 90° and wherein the second crank arm has a second crank arm recovery stroke which is 270°.
